(19) United States
(12) Patent Application Publication
(10) Pub. No.: US 2004/0202326 A1
(43) Pub. Date: Oct. 14, 2004

(54) System and methods for real-time encryption of digital images based on 2D and 3D multi-parametric chaotic maps

(76) Inventors: Guanrong Chen, Kowloon (HK); Charles K. Chui, Menlo Park, CA (US)

Correspondence Address: BOSE MCKINNEY & EVANS LLP, 135 N PENNSYLVANIA ST, SUITE 2700, INDIANAPOLIS, IN, 46204, US

(21) Appl. No.: 10/410,916

(22) Filed: Apr. 10, 2003

(51) Int. Cl. H04L 9/00

(52) U.S. Cl. 380/263

(57) ABSTRACT

Two classes of new chaotic maps are introduced in this invention for real-time encryption of digital images: A first method that utilizes a parametric family of 2×2 generalized chaotic cat maps for shuffling the spatial positions together with Chen's chaotic map for key generation. This is a line-based system that enables real-time encryption, in that image encryption is performed line by line while the image is being scanned. Off-line or parallel processing in pixel shuffling and key generation facilitates real-time applications. In this first method, gray values of the image pixels are treated by a diffusion technique. A second method utilizes an extended parametric family of 3×3 generalized chaotic cat maps for both pixel-positions and gray-values shuffling. For the two proposed new methods, reversible (i.e., lossless) compression algorithms are integrated as an option of the cryptosystem.

### FIELD OF THE INVENTION

The present invention relates generally to cryptography, and in particular, to methods for the encryption of digital images based on the chaos theory of discrete dynamical systems.

### BACKGROUND OF THE INVENTION

Cryptography has a very long history, dating back to the Egyptian days some four thousand years ago. However, the best-recorded cryptosystem is the Caesar cipher used by Julius Caesar for military applications. The secret key of the Caesar cipher is a single natural number, n, that dictates the number of shifts in position of all letters of a message to be encrypted, in a cyclic fashion. This is a symmetric-key encryption algorithm, since the same key, n, is used to decrypt the message by n backward shifts of all letters, again in a cyclic fashion.

Indeed, symmetric-key cryptosystems based on elementary mathematical operations of permutations, congruence arithmetic, matrix multiplications, iterations, etc., had been the only ones available until the mid 1970's, when Diffie and Hellman introduced the public-key cryptography. Furthermore, DES (Data Encryption Standard) had been the U.S. encryption standard before the Rijndael algorithm was adopted in October 2000 as a new advanced encryption standard (AES). Both DES and AES are based on symmetric-key encryption algorithms, with the decryption key being identical to the encryption key, or easily derivable from it.

In contrast to symmetric-key cryptosystems, public-key cryptography is based on asymmetric-key encryption, with a public key for encryption and a private key for decryption. The first practical public-key encryption scheme was introduced by Rivest, Shamir, and Adleman in 1978, known as the RSA scheme today, and since then there have been very active research activities in cryptography that engage modern mathematical tools, such as the theories of Elliptic Curves and Hyper-elliptic Curves.

However, even with the recent research advancement, the significant disadvantages of public-key encryption in the need of an extraordinary long key and in the extremely slow throughput rate cannot be avoided, not to mention the need for an absolutely trustable authentication agency and other problems (e.g., it cannot support “non-repudiation”—important for electronic transactions). On the other hand, current symmetric-key approaches are not suitable for secure encryption of digital images for at least two reasons: Firstly, the confusion in pixel shuffling and diffusion in gray values are usually not thorough enough to avoid intelligent detection and statistical analysis; and secondly, the key spaces are in general too small for secure performance of several iterations.

Although chaos-based approaches have been used for image encryption for some time, the above technical issues have not been properly addressed or resolved. There are several reasons for this, the main one being that all the chaotic maps used thus far are relatively simple without sufficient parameters that can significantly enlarge the key space for encryption. These provide strong motivation for the development of the proposed new chaos-based methods.

### SUMMARY OF THE INVENTION

According to the present invention there is provided a method for encrypting an image data array, comprising the steps of: (a) diffusing the image pixel values by means of a nonsingular matrix transformation; (b) shuffling the image pixel positions; and (c) encoding the shuffled and diffused pixels. The invention also extends to a corresponding inverse decryption method.

The present invention, at least in its preferred forms, provides a system and a real-time methodology for line-by-line encryption/decryption of a digital image. The cryptosystem can be integrated with an image scanner to allow for line-based encryption while an image is being scanned. More precisely, input of a binary key chain enables pixel value diffusion during the scanning process, while shuffling of pixel positions according to a set of integer pairs of keys is carried out, again line by line. The algorithms for pixel value diffusion and pixel position shuffling using generalized chaotic maps, including a 2D generalized cat map and a discrete version of Chen's chaotic map, developed by the inventors, is designed to generate the binary key chain and the integer pairs of keys. Key generation and pixel position shuffling could be carried out in parallel or off-line, since the only image information needed for the later process is merely the image size.

The second method proposed is a combination of the above diffusion and confusion schemes as an alternative approach. While the image is being scanned, the spatial positions and gray values of scanned pixels will be thoroughly shuffled by a specially designed chaotic map (a 3D generalized cat map), encrypted by a binary key chain generated with the discrete Chen's chaotic map. Again, off-line parallel processing in pixel shuffling and key generation facilitates real-time applications of the proposed cryptosystem based on this alternative methodology.

For communication systems, the encrypted image lines are to be sent to the receiver. Information on image size should be sent first, for the receiver to re-generate the key chain thereby facilitating real-time decryption. The receiver uses the same (symmetric) integer pairs of key set for un-shuffling the position values of the image pixels upon receipt of the image size information before the arrival of the (coded) encrypted image bit-stream. The same (symmetric) binary key is used for decryption of the diffused pixel values.

Both the integer pairs of key set and binary key chain are re-generated by the same chaotic maps on the receiver. A password could be applied to receive the encryption parameters of the chaotic maps used on the transmitter.

### BRIEF DESCRIPTION OF THE DRAWINGS

Some embodiments of the invention will now be described by way of example and with reference to the accompanying drawings, in which:

FIG. 1 is a schematic block diagram of an encryption system according to an embodiment of the invention,

FIG. 2 is a schematic block diagram of a pixel position shuffling system for use in an embodiment of the invention,

FIG. 3 is a schematic block diagram of a decryption system according to an embodiment of the invention,

FIG. 4 is a schematic block diagram of a pixel position un-shuffling system according to an embodiment of the invention, and

FIG. 5 shows the complex attractor of the chaotic Chen's system for use in an embodiment of the invention

### DETAILED DESCRIPTION OF PREFERRED EMBODIMENTS

Before describing some preferred embodiments in detail, it should firstly be understood that an important aspect of systems according to preferred embodiments of the present invention is the use of novel chaotic maps generalizing the standard cat map, which have a large enough parameters space required by encryption. These generalized (parametric) chaotic cat maps, used for data shuffling, diffusion and confusion, will be described in more detail below, in which the two parameters, a and b, can be different from iteration to iteration, thereby significantly increasing the size of its key space, hence the encryption complexity. This chaotic map is invertible, and has the best possible mixing property for pixel confusion. In a rectangular domain, the map can be modified accordingly by image segmentation.

The diffusion of image gray values is very important, which is critical for prevention of statistical attack by analyzing the histogram of the image. Although more sophisticated design is possible, here another simple chaotic map is used to diffuse the image gray values. Using this generalized chaotic map, the gray values of the image are diffused by taking the steps of operations to be further described in the next section.

The chaotic Chen's system, discovered by the inventors and used in the proposed scheme, is given by

$$\{ \begin{matrix}{x}^{′} = a ( y - x ) \\ {y}^{′} = ( c - a ) x - xz + cy \\ {z}^{′} = xy - bz , \end{matrix}$$

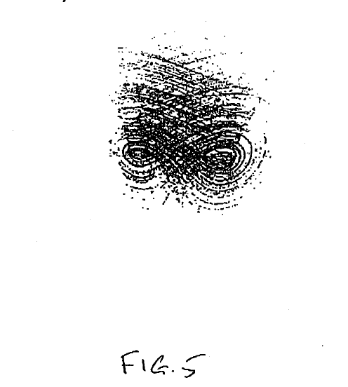

which is chaotic when its parameters are a=35, b=3, c=28. FIG. 5 shows its complex chaotic attractor. It is known that its z-component is the most sensitive one among the three, so the z component is used for key generation here. Similar to the famous Lorenz chaotic system, Chen's system has a topologically very complex attractor.

The 2D parametric chaotic cat map can also be extended to a 3D version, as will be described below, which can be used to shuffle both positions and gray values of pixels together at the same time. This provides another option for the intended task of image encryption.

At least in preferred embodiments, the present invention relates to a system and method that comprise three main components: pixel position value shuffling, pixel gray value diffusion, and symmetric key chain generation, where the latter is used to secure (encrypt) the former operations. Preferably, only linear transformations are used for pixel value shuffling, thereby yielding a fast real-time scheme for image encryption. In particular, the specially designed generalized chaotic maps (and their inverses) that will be described below are used to perform these linear transformations. For an integer-pair key (a,b), all the matrices have only integer entries, therefore are easily manipulated without any information loss.

An embodiment of the invention will firstly be discussed with reference to the encryption system, including pixel position encryption (and then subsequent decryption including pixel position decryption), key generation based on Chen's system, and finally encoding/decoding techniques.

Encryption System

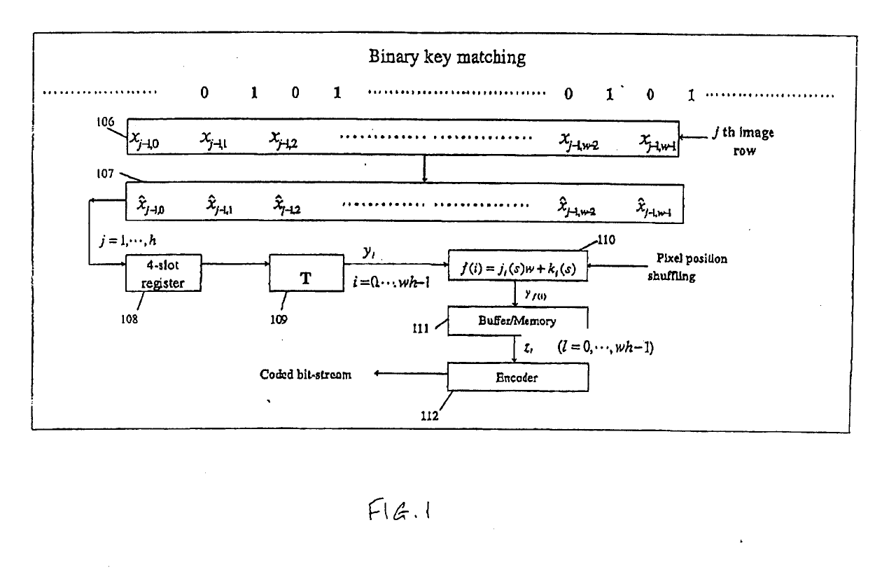

FIG. 1 shows the basic encryption system according to a preferred embodiment of the present invention. The system design of the preferred embodiment is aimed at the raster format; that is, encryption is performed line by line from left to right, starting from the first line, then the second line, and so on

The following illustrates a digital image of size w×h with pixel values x_{j,k}, j=0, . . . , h−1; k=0, . . . , w−1:

$$\begin{matrix}{X}_{00} & {X}_{01} & ⋮ & {X}_{0 , w - 1} \\ {X}_{10} & {X}_{11} & ⋮ & {X}_{t , w - 1} \\ ⋯ & ⋯ & & ⋯ \\ {X}_{h \cdot 1 , 0} & {X}_{h \cdot 1 , 1} & ⋮ & {H}_{h - 1 , w - 1}\end{matrix}$$

A binary key chain of arbitrary length is used to match the pixels on each line, pixel by pixel. As usual, the key chain is to be repeated periodically if the length is shorter than the total number of pixels of the image. A match with the first 1 bit, of a string of one or more than one bit, flips the 0 and 1 bits of the pixel value. If the next pixel is again matched with a 1 bit of the key chain (i.e., the first 1 bit of the key is followed by another 1 bit), then the second pixel value is multiplied by 2 (i.e., a left bit-shift). If the following pixel is again matched with 1, then its value is increased by 1 after being multiplied by 2 (i.e., left bit-shift with 1 instead of 0 to fill the bit slot). This takes care of a key with a block of three 1's. If the string of 1's of this key segment is larger than 3, then the fourth 1 is changed to 0. In other words, the block size of 1's is restricted to at most 3. A match with a zero bit leaves the pixel value unchanged. This is only a simple example of how a pixel value may change according to matching with a binary key, and it will be understood that other operations, either more involved or simpler, can be used.

Referring to FIG. 1, the jth row of the image with pixel values x_{j-1.0}, . . . , x_{j-1, w-1} in the register 106 are changed to \hat{x}_{j-1.0}, . . . , \hat{x}_{j-1, w-1} in the register 107, after being matched with the binary key. Here, w denotes the image width (or the number of pixels in each row) and specifies the number of slots needed in the registers 106 and 107. Since the raster format is followed, the encrypted wh pixels (where h denotes the image height, or the number of rows) are directed to a 4-slot register 108 in the order shown below:

x₀₀,x₀₁, . . . ,x_{0,w-1},x₁₀,x₁₁, . . . ,x_{1,w-1}, . . . ,x_{h-1.0}, . . . ,x_{h-1,w-1}

It is required that both w and h are integer multiples of 4. Each segment of 4 pixel values is diffused by matrix multiplication 109 using the 4D matrix T, which is the inverse of a specially designed generalized chaotic cat map (given in the Decryption System Section below) and is described by

$$T = [ \begin{matrix} 2 & - 1 & - 2 & - 1 \\ - 3 & 2 & 3 & 1 \\ - 2 & 1 & 3 & 1 \\ 4 & - 2 & - 4 & - 1\end{matrix} ]$$

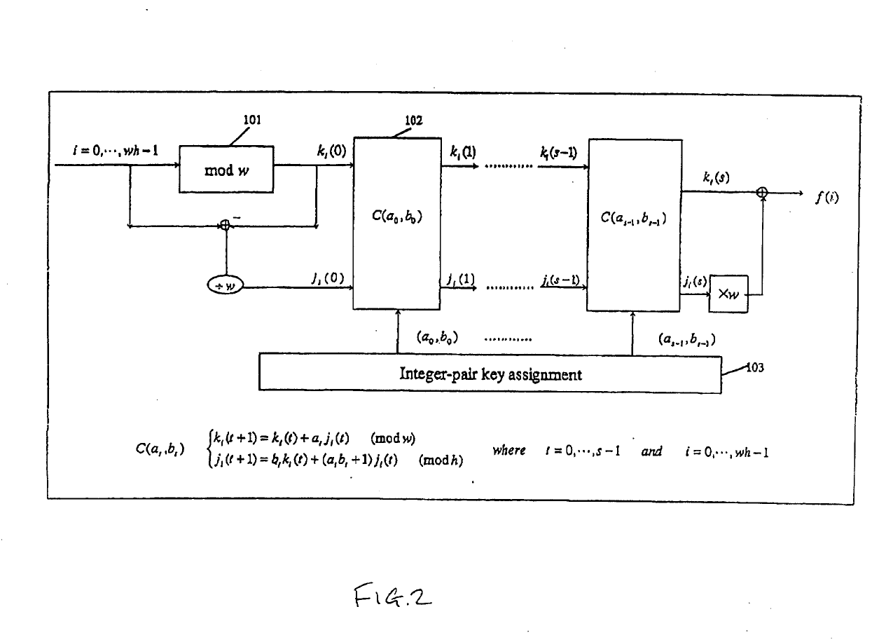

The diffused pixel values, labeled yᵢ,i=0, . . . , wh−1, in FIG. 1, are then shuffled according to the scheme shown in FIG. 2 (to be described in more detail later).

The ith value yᵢ is put in the f(i)th position in the buffer/memory 111. The worst situation (i.e., the maximum amount of memory required) is the full wh pixel positions. Once the first few slots of 111 are filled, die shuffled values yᵢ (now in the order of z₀,z₁, . . . , z_{wh-1}, are directed to the encoder 112 for coding. Finally, the coded bit-stream is sent to storage or to receiver (for decoding and decryption).

In an alternative preferred embodiment, in order to cut down memory needed in 111, the image is partitioned into strips of h₁ lines each and h₁ is an integer multiple of 4. In other words, for 0<h₁<h, and h=nh₁+h₂ where 0<h₂2h₁, the image is partitioned into n+1 strips, with each of the first n strips consisting of h₁ rows, and the last (i.e., the (n+1)st strip) consisting of h₂ rows. In so doing, the memory requirement is cut down significantly since each image strip is considered as an individual image for encryption.

In another preferred embodiment, if the register size of 106 and 107 in FIG. 1 is to be reduced to w₁ slots instead of w slots, where w₁ is an integer multiple of 4, then the image can be partitioned into blocks of w₁×h₁ each, except for the blocks on the right-hand boundary and the bottom boundary. Here, w=mw₁+w₂, with 0<w₂<2w₁, where m+1 vertical strips are considered, in which each of the first m vertical strips consists of lines with width w₁ and the last vertical strip consists of lines of w₂ in width. Each of the (m+1)(n+1) blocks is encrypted in the same manner as the entire image is encrypted as a whole.

FIG. 2 schematically illustrates the pixel position shuffling method.

Encryption of pixel positions can be carried out off-line or in parallel, since the only information required for this operation is image width w and height h (or w₁,w₂ and h₁,h₂, etc. if strips or blocks of the image are encrypted individually). The one-to-one map between linear ordering (i=0,1, . . . ,wh−1) and pixel positions ((j,k), j=0,1, . . . , w−1; k=0,1, . . . , h−1) may be described as follows:

$$\begin{matrix}i = 0 , 1 , … , wh - 1 ( {j}_{i ,} {k}_{i} ) & & & & \\ \{ \begin{matrix}{k}_{i} = i ( mod w ) , 0 & {k}_{i} & t ; \\ {j}_{i - ( i} - {k}_{j} ) / w . & & \end{matrix} & & & & \\ ( j , k ) l = jw + k , & & & & \\ 0 \begin{matrix}kw - 1 , 0 & j & h - 1\end{matrix} & & & & \end{matrix}$$

Hence, the linear ordering (i=0,1, . . . , wh−1) is first mapped to the pixel position ordering (jᵢ(0),kᵢ(0)) via the mod-w operation 101 (and ⊕,÷w operations) as shown in FIG. 2. A set of s keys, each being an integer-pair in unit 103, is used to encrypt (jᵢ(O),kᵢ(0)) iteratively, as shown in 102 for the key (a₀,b₀), etc., and the encryption algorithm is shown in FIG. 2, using the 2D generalized chaotic cat map (designed by the inventors)

$$C ( x , y ) = [ \begin{matrix}1 & a \\ b & ab + 1\end{matrix} ] [ \begin{matrix}x \\ y\end{matrix} ] ( mod N )$$

which is a parameterized chaotic cat map with integer parameters (a,b), where 0<a,b<N, and N is the dimension of a square image with w=h. The encrypted positions (jᵢ(s),kᵢ(s)) after s iterations are put in the linear ordering positions, indicated by f(i): meaning that the ith position is now the f(i)th position.

Decryption System

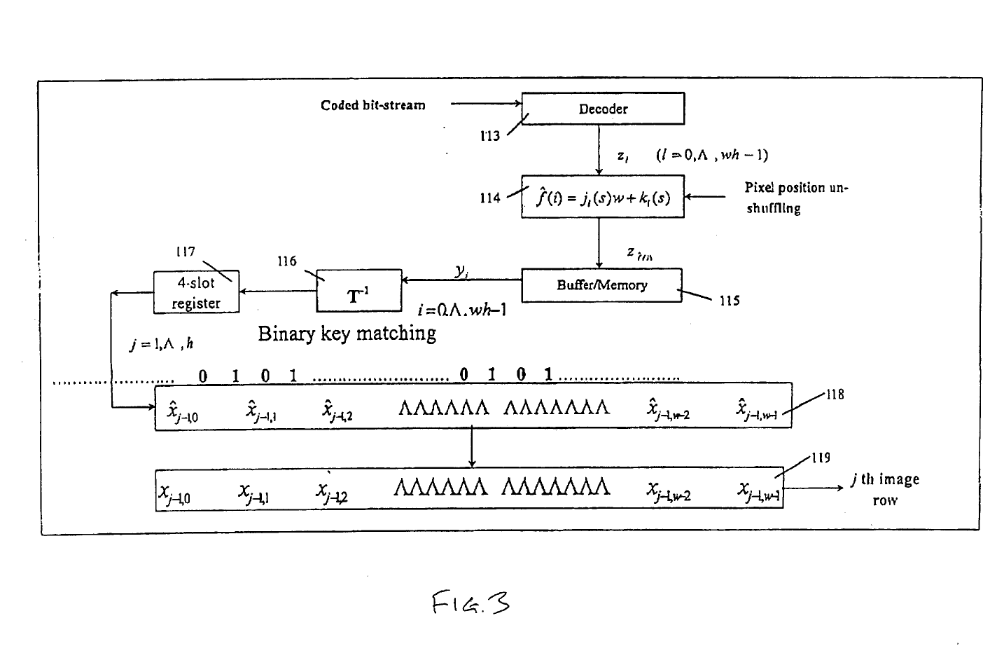

The decryption system is shown in FIG. 3 and will be described below. The decryption system carries out the inverse operations of the encryption system outlined above. Hence, information about image width w and image height h (or w₁, w₂ and h₁, h₂, etc. if strips or blocks of the image are encrypted) are first sent to the un-shuffling unit 114 (described in detail below with reference to FIG. 7) to arrange the decoded values z₁ from 113 to the original raster positions (shown as z_{g(i)} or yᵢ). The arrangement is stored in the buffer/memory unit 115 and directed to the 4-slot register 119, as soon as the first four values in 115 are in place. The inverse diffusion matrix T⁻¹ in 117 is the following 4D generalized chaotic cat map:

$${T}^{- 1} = [ \begin{matrix}1 & 1 & 1 & 1 \\ 1 & 2 & 0 & 1 \\ 1 & 0 & 1 & 0 \\ - 2 & 0 & 0 & 1\end{matrix} ]$$

and this is then applied to blocks of 4 values, which are then sent to register 116. When the register 116 is full, these values are decrypted by matching with the symmetric binary key, and each line of the image (or block of the image) is decrypted.

The same set of s integer-pair keys (a₀,b₀), . . . , (aₛ₋₁, bₛ₋₁) are used for decryption as for encryption. This is shown below:

$${C}^{- 1} ( x , y ) = [ \begin{matrix}ab + 1 & - a \\ - b & 1\end{matrix} ] [ \begin{matrix}x \\ y\end{matrix} ] ( mod N )$$

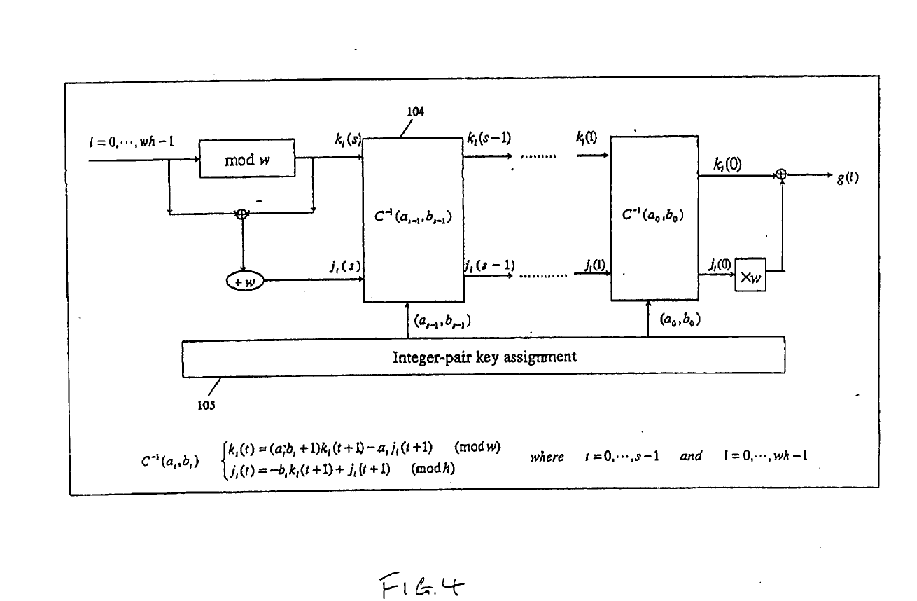

First, the lth position, l=0,1, . . . , wh−1, is mapped to the pixel position (jᵢ(s), kᵢ(s)) and decrypted in 104 by the first key (aₛ₋₁,bₛ₋₁) from 105. The same decryption process is iterated by applying the keys (aₛ₋₂,bₛ₋₂), . . . , (a₀, b₀) to the original line position. The decryption equation is also shown in FIG. 4, using the 2D inverse generalized chaotic map.

$$( \begin{matrix}ab + 1 & - a \\ - b & 1\end{matrix} )$$

Key Generation

The map control parameters (a, b) and the iteration round number L are chosen as cipher keys. In order to further enlarge the key space, in each iteration of the generalized cat map

$$( \begin{matrix}1 & a \\ b & ab + 1\end{matrix} ) ,$$

different pairs of a, b are used. If L iterations of the map are performed on an image, the cipher keys is

{a₁,b₁,a₂,b₂, . . . ,a_{L},b_{L}, L},

which has a large enough key space. Here, L can be used as the length of the password, for instance, so that the longer the password, the more secure the encryption, depending on the user's preference in an application.

A general procedure for generating a key is described as follows: Firstly, a serial of characters used for cipher key are mapped into floating-point numbers in (0,1). Secondly, m₁ and m₂ times of iterations are performed on the generalized cat map to get y₁ and y₂, and then y₁ and y₂ are transformed into integers a₁ and b₁ respectively to yield the two map control parameters at its first iteration. This process will continue for L times, where L is the length of the password (i.e., the cipher rounds).

It should be noted that a cryptosystem with only a large enough key space is still not very secure, because an eavesdropper can use certain cryptoanalysis methods to lessen the key-searching. In order to make this kind of cryptoanalysis infeasible, the cryptosystem should be carefully designed such that it is extremely sensitive to the key. In preferred embodiments of the present invention, the discrete version of the chaotic Chen's map is used for key generation. The continuous version of Chen's attractor is shown in FIG. 5.

To generate a key from Chen's system:

Step 1. Input an L-character password (e.g., L=16), and then divide it into two groups: even and odd. Add the ASCII values of all characters in the even group, and do the same on the odd group, respectively, thereby obtaining two values; Kₑᵥₑₙ and K_{odd}. Using the following formulas to get the control parameter, c, of Chen's system:

cₕ=(Kₑᵥₑₙ mod H)/H*8.4+20

c_{w}=(K_{odd} mod W)/W*8.4+20

where cₕε[20,28.4] and c_{w}ε[20,28.4]. H stands for the image height and W for the image width, subscripts h and w indicate the corresponding height direction and width direction of image, respectively.

Initial values x₀,y₀,z₀ of Chen's system can also be derived from Kₑᵥₑₙ and K_{odd} by using the following formulas:

x₀ₕ=(Kₑᵥₑₙ mod H)/H*80−40

y₀ₕ=(K_{odd} mod H)/H*80−40

z₀ₕ=(Kₑᵥₑₙ mod H)/H*60

x_{0w}=(K_{odd} mod W)/W*80−40

y_{0w}=(Kₑᵥₑₙ mod W)/W*80−40

z_{0w}=(K_{odd} mod W)/W*60

Step 2. Set parameters a=35, b=3, and use other parameters obtained from Step 1. Then, iterate Chen's system say 500 times for the height direction and the width direction, respectively, so as to obtain two values: z₅₀₀ₕ,z_{500w}.

Step 3. Use the following formulas to obtain the final parameter values of a and b for the generalized cat map, where a corresponds to the height direction and b corresponds to the width direction:

a=round(zₕ/60*H)

b=round(z_{w}/60*W)

Encoding/Decoding

Prediction followed by Huffman coding is used in the preferred embodiment for encoding the output zₗ, l=0,1, . . . , wh−1, in FIG. 1. To save memory and avoid propagation error, L-term prediction, with 2≦L≦64, is used in the preferred embodiment. Adaptive Huffman coding is used in the beginning, till a suitable Huffman table is established. Run-length coding is an option, with or without Huffman coding.

In another preferred embodiment, the values zₗ,l=0,1, . . . , wh−1, are arranged in N×N square blocks, one at a time, with N=8, 16, 32, or 64, and here w=h.

The encoding scheme called “Nested quadratic split coding” as described in U.S. Pat. No. 5,748,116 (entitled “System and method for nested split coding of sparse data sets”) of the inventors is used. A Huffman table, developed for this approach as well, is used following the nested quadratic split coding.

While the present invention has been described with reference to a specific embodiment, and a few variations, the description is illustrative of the invention and is not to be construed as limiting the invention. Various modifications may occur to those skilled in the art without departing from the true spirit and scope of the invention as defined by the appended claims.

As an alternative approach, for example, the generalized chaotic cat map may be extended from 2D to 3D, as shown below:

$$C ( x , y , z ) = [ \begin{matrix}1 & {a}_{y} {b}_{z} & {a}_{y} ( {a}_{x} {b}_{x} + 1 ) \\ {b}_{z} & {a}_{z} {b}_{z} + 1 + {b}_{z} {a}_{y} {b}_{x} & {a}_{x} ( {a}_{z} {b}_{z} + 1 ) + {b}_{z} {a}_{y} ( {a}_{x} {b}_{x} + 1 ) \\ {b}_{y} & {b}_{x} ( {a}_{y} {b}_{y} + 1 ) & ( {a}_{y} {b}_{y} + 1 ) ( {a}_{x} {b}_{x} + 1 )\end{matrix} ] ( mod N )$$

where all 0<a,b<N, and N is the dimension of the square image.

This enables the following modification and improvement of the above-described encryption scheme: The spatial positions as well as the gray values of the scanned pixels can be thoroughly shuffled by the specially designed new 3D generalized cat map, encrypted in parallel by a binary key chain generated with the complex Chen's chaotic map, which only needs the information of the image size and password length but nothing else beforehand. Similarly, the off-line parallel processing in pixel shuffling and key generation can facilitate the real-time application of the modified algorithm.

It will also be understood that the embodiments described above could be applied to a wide range of different data elements and different types of data files, such as the following ten different formats of data files (readable images): tif, jpg, png, bmp, rgb, rgba, cel, tga, gif, pcx; and the following six different formats of writable images: jpg, tif, png, bmp, rgb, rgba

What is claimed is:

1. A method for encrypting an image data array, comprising the steps of:
(a) diffusing the image pixel values by means of a nonsingular matrix transformation;
(b) shuffling the image pixel positions; and
(c) encoding the shuffled and diffused pixels.

2. A method as claimed in claim 1, wherein a set of keys is used to dictate the shuffling algorithm.

3. A method as claimed in claim 1, wherein a binary key chain is used to change the pixel values before or after the diffusion transformation.

4. A method as claimed in claim 1, wherein in step (a) the diffusion matrix is the inverse of a 4D generalized chaotic cat map.

5. A method as claimed in claim 1, wherein in step (b) pixel position shuffling is governed by a 2D generalized chaotic cat map with a large number of parameters.

6. A method as claimed in claims 2 and 3, wherein the keys and the binary key chain are generated by a chosen password and by Chen's chaotic system with a chosen iteration number, respectively.

7. A method as claimed in claim 6, wherein the password is mapped to the parameters of the 2D generalized chaotic cat map.

8. A method as claimed in claim 7, wherein the chaotic map is the discrete version of Chen's chaotic system.

9. A method as claimed in claim 7, wherein the chaotic map is a two-dimensional map.

10. A method as claimed in claim 8, wherein the chaotic map is a three-dimensional map.

11. A method as claimed in claim 1, wherein the image data array is raster-scanned lines of an image.

12. A method as claimed in claim 1, wherein the step of data element-position shuffling is performed off-line or in parallel to the key generation.

13. A method for decrypting an encrypted image date array comprising the steps of
(a) decoding shuffled and diffused pixels,
(b) unshuffling the diffused pixels using an inverse shuffling scheme, and
(c) applying an inverse nonsingular matrix transformation to recover diffused pixel values.

14. A method as claimed in claim 13, wherein in step (a) a set of keys is used to decode the shuffled and diffused pixels in a form of data element array.

15. A method as claimed in claim 13, wherein in step (a) a binary key chain is used to backward change the data element values obtained from the 4D inverse diffusion transformation.

16. A method as claimed in claim 13, wherein in step (a) the 4D inverse diffusion matrix is an inverse chaotic map.

17. A method as claimed in claim 13, wherein in step (b) pixel position un-shuffling is governed by the inverse of a 2D generalized chaotic cat map used to shuffle the pixel positions.

18. A method as claimed in claims 14 and 15, wherein the keys and the binary key chain are generated by the received password and by Chen's chaotic system with the received iteration number.

19. A method as claimed in claim 18, wherein the keys are used to decode the parameters of a 2D chaotic map.

20. A method as claimed in claim 13, wherein said image array is the encrypted raster-scanned lines of an image.

21. A method as claimed in claim 13, wherein in step (b) pixel position un-shuffling is performed off-line or in parallel to the key re-generation.

22. A method as claimed in claim 13, wherein in step (b) pixel position un-shuffling is performed by an inverse shuffling scheme.

23. A method as claimed in claim 22, wherein the inverse shuffling scheme uses the inverse of the 2D generalized chaotic cat map.

24. A method as claimed in claim 13, wherein in step (c) the nonsingular matrix transformation is the 4D generalized chaotic cat map.

25. A method as claimed in claim 1, wherein a larger image is partitioned into blocks, and the said image array represents pixels of an individual image block.
